(19) United States
(12) Patent Application Publication
(10) Pub. No.: US 2011/0203953 A1
(43) Pub. Date: Aug. 25, 2011

(54) Musical Instrument Case Exterior Accessory Pack

(76) Inventor: James W. Fowler, II, Huntsville, AL (US)

(21) Appl. No.: 12/712,367

(22) Filed: Feb. 25, 2010

(51) Int. Cl. A45C 11/00; G10D 9/00

(52) U.S. Cl. 206/314; 84/453

(57) ABSTRACT

An accessory pack for a musical instrument case comprises a sleeve dimensioned to fit on the exterior of the musical instrument case body first and second openings at either end of the sleeve through which the case is inserted, and a third opening defined in the wall of the sleeve. Additionally, one or more pockets can be located on the outer surface of said sleeve.

### BRIEF DESCRIPTION OF THE DRAWINGS

The present disclosure is described with reference to the accompanying drawings. In the drawings, like reference numbers indicate identical or functionally similar elements.

FIG. 1 is a front view of an exemplary musical instrument case exterior accessory pack and a musical instrument case;

FIG. 2 is a front view of the exemplary exterior accessory pack of FIG. 1 being placed around the musical instrument case.

FIG. 3 is a front view of the exemplary exterior accessory pack of FIG. 1 properly positioned upon the musical instrument case.

FIG. 4 is a front view of another embodiment of an exemplary exterior accessory pack properly positioned upon a musical instrument case.

FIG. 5 is a front view of another embodiment of an exemplary exterior accessory pack.

FIG. 6 is a front view of another embodiment of an exemplary exterior accessory pack.

### DETAILED DESCRIPTION

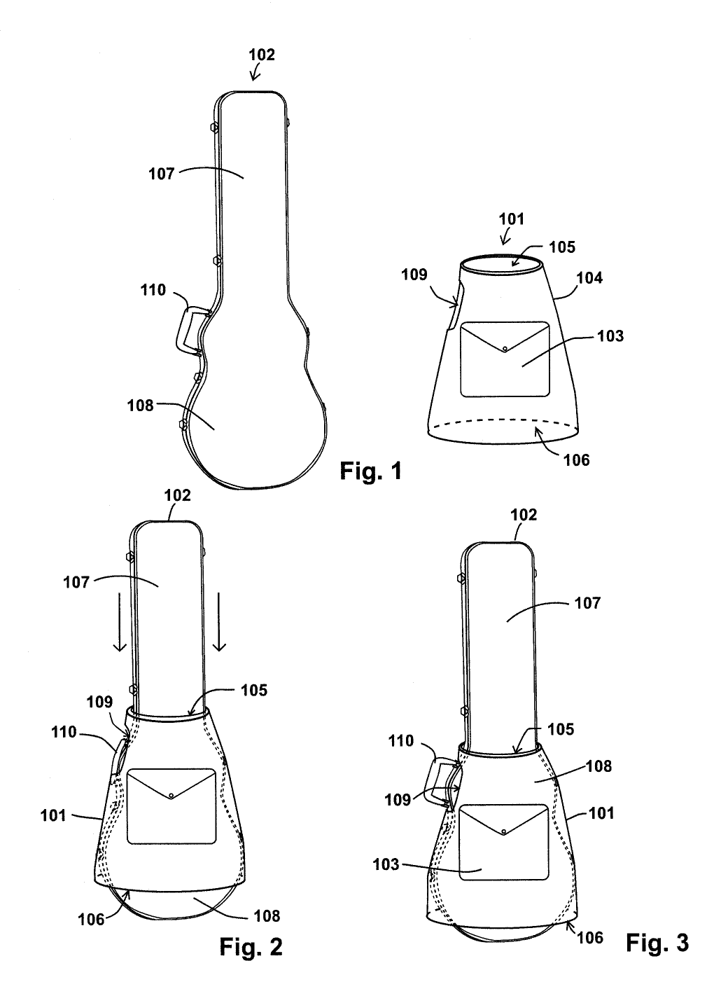

The various embodiments of the present disclosure and their advantages are best understood by referring to FIGS. 1 through 6 of the drawings. The elements of the drawings are not necessarily to scale, emphasis instead being placed upon clearly illustrating the principles of the disclosure. Throughout the drawings, like numerals are used for like and corresponding parts of the various drawings.

The drawings represent and illustrate examples of the various embodiments of the disclosure, and not a limitation thereof. It will be apparent to those skilled in the art that various modifications and variations can be made in the present embodiments without departing from the scope and spirit of the disclosure as described herein. For instance, features illustrated or described as part of one embodiment can be included in another embodiment to yield a still further embodiment. Moreover, variations in selection of materials and/or characteristics may be practiced to satisfy particular desired user criteria. Thus, it is intended that the present disclosure covers such modifications as come within the scope of the features and their equivalents.

Furthermore, reference in the specification to “an embodiment,” “one embodiment,” “various embodiments,” or any variant thereof means that a particular feature or aspect of the disclosure described in conjunction with the particular embodiment is included in at least one embodiment of the present disclosure. Thus, the appearance of the phrases “in one embodiment,” “in another embodiment,” or variations thereof in various places throughout the specification are not necessarily all referring to its respective embodiment.

FIG. 1 depicts an exemplary musical instrument case exterior accessory pack, and a musical instrument case. The exterior accessory pack 101 is configured to be placed around the outside of the musical instrument case 102, such as, for example, a guitar case. The accessory pack 101 has one or more pockets 103 located on its outer surface for storing various musical instrument accessories such as sheet music, straps, picks, cleaning materials and other essential items. It will be appreciated that the pack contemplated herein can be used with nearly any type of case for a musical instrument, including without limitation, cases for stringed instruments, e.g., cello, violin, mandolin, etc., cases for electronic keyboards, or even cases for drums. A guitar case is only used in this description as an illustrative example. In one embodiment, the exterior accessory pack 101 comprises a single piece of lightweight material uniformly woven into a sleeve 104 having an upper opening 105 and a lower opening 106. Typical guitar musical instrument cases 102 comprise a neck 107, a lower body portion 108, and a handle 110. The lower opening 106 receives the musical instrument case 102 in order to allow the pack 101 to fit over the outside of the case 102, while the upper opening 105 receives the neck 107 of the case 102 such that the pack 101 fits snugly around the lower portion 108 of the case 102. The pack 101 also has an aperture 109 for receiving the handle 110 of the case 102. While the present embodiment discloses a sleeve 104 uniformly woven into a single piece of material, other embodiments utilizing multiple pieces of material are possible without departing from the scope of the present disclosure.

When utilized properly, the exterior accessory pack 101 fits snugly around the body 108 of the musical instrument case 102 while allowing the neck 107 and the handle 110 of the case 102 to extend through the upper opening 105 and the aperture 109, respectively, and remain exposed. In this orientation, the pockets 103 are located on the outer surface of the pack 101 in order to allow easy access to the accessories while the pack 101 is positioned upon the case 102. When positioned upon the case 102, the exterior accessory pack 101 stores essential items and allows a user to carry the case 102 and pack 101 as a single lightweight unit, eliminating the need for additional bags or carrying cases. Notably, the pack 101 is dimensioned according to the size of the case 102, and packs 101 of varying dimensions may be utilized with cases 102 of different sizes.

FIG. 2 depicts the exemplary musical instrument case exterior accessory pack 101 of FIG. 1 in the process of engaging with a musical instrument case 102. As shown in FIG. 2, the exterior accessory pack 101 is positioned upon the musical instrument case 102 by placing the lower opening 106 around the neck 107 and sliding the pack 101 over the case 102 until the neck 107 extends through the upper opening 105 and the pack 101 is positioned over the body 108 of the case 102. Notably, the upper opening 105 is smaller than the lower opening 106 such that the upper opening 105 will not fit around the body 108 of the case 102. Thus, when the pack 101 is pulled down over the body 108 of the case 102, the upper opening 105 rests at the top of the body 108 near where the neck 107 and body 108 meet. The handle 110 then extends up through the aperture 109, as shown in FIG. 3, to allow optimum portability of the case 102 while the pack 101 is positioned upon it. Thus, when the pack 101 is properly positioned upon the case 102, the pack 101 covers the body 108 of the case 102 but not the neck 107 or the handle 110. Such an exposed handle 110 allows a user to transport the case 102 normally while the pack 101 is positioned upon the case 102. Although the pack 101 of the embodiment is shown to substantially cover the body 108 of the case 102, other embodiments which cover larger or smaller portions of the case 102 are possible without departing from the scope of the present disclosure.

The pack 101 may be made from a flexible, lightweight material, either knitted, or woven, with sufficient elasticity to easily stretch around the case 102 while also fitting snugly to the case 102. Non-limiting examples of suitable materials include cotton-based knitted fabrics, synthetic or blended fabrics, Lycra®, and even neoprene. Additionally, those skilled in the art will recognize that a relatively non-elastic material may be used as long as it is dimensioned to receive the case 102 body 108. The pocket 103 is positioned on the outer surface of the pack 101 such that musical instrument accessories may be stored and easily accessed when the pack 101 is properly positioned around the body 108 of the case 102.

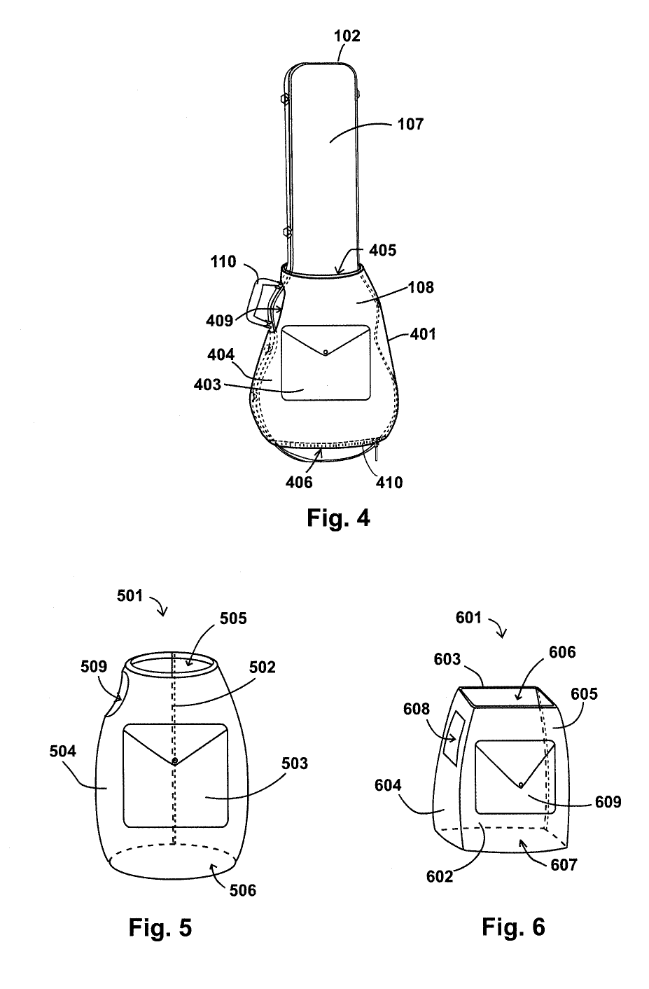

FIG. 4 depicts another embodiment of an exterior accessory pack positioned upon a musical instrument case. The pack 401 comprises a sleeve 404 made of flexible, lightweight material and a pocket 403 positioned upon the outer surface of the sleeve 404. The sleeve 404 has an upper opening 405, a lower opening 406, and an aperture 409. The lower opening 406 is larger than the upper opening 405 such that the lower opening 406 fits around the body 108 of the musical instrument case 102, but the upper opening 405 does not. The aperture 409 receives the handle 110 of the musical instrument case 102 in order to facilitate normal transportation of the case 102 when the pack 401 is positioned upon the case.

In this embodiment, the pack 401 further comprises a drawstring 410 positioned around the rim of the lower opening 406 such that the lower opening 406 may be drawn tightly around the bottom of the case 102. The drawstring 410 allows the pack 401 to fit snugly to the outer surface of the case 102 on all sides of the case 102, and be restrained from sliding back toward the neck 107, and potentially disengaging from the case 102. Although a drawstring 210 is disclosed, it will be recognized that other means for adjusting the circumference of the lower opening 406 of the pack 401, such as, for example, an elastic band sewn in or attached to the pack 401 about the circumference of the lower opening 406, may be utilized without departing from the scope of the present disclosure.

FIG. 5 depicts another embodiment of an exterior accessory pack. The exterior accessory pack 501 of FIG. 5 comprises a single sheet of material formed into a somewhat conical-shaped sleeve 504 by coupling opposite edges of the sheet along a seam 502. Again, the pack 501 has a pocket 503 positioned on its outer surface, and an upper opening 505 and a lower opening 506 for receiving the musical instrument case 102 (FIG. 1). The pack 501 also has an aperture 509 for receiving the handle 110 (FIG. 1) of the case 102 (FIG. 1).

FIG. 6 depicts another embodiment of an exterior accessory pack. The exterior accessory pack 601 of FIG. 6 comprises a front panel 602, a back panel 603, and two side panels 604, 605. One edge of the front panel 602 is coupled to the side panel 604 and the other edge of the front panel 602 is coupled to the side panel 605. The side panels 604, 605 are also coupled to opposite edges of the back panel 603, forming a somewhat box-shaped pack 601 having an upper opening 606 and a lower opening 607. The side panel 604 has an aperture 608 for receiving the handle 110 (FIG. 1) of the musical instrument case 102 (FIG. 1), and the front panel 602 has a pocket 609 for storing musical instrument accessories (not shown).

Notably, the pack 601 is formed by sewing the panels 602-605 together at their edges, but other means for coupling the panels to one another may be utilized. Although the pack 601 discloses only one pocket 609 located on the front panel 602, more pockets 609 may be located at various positions on the pack 601 without departing from the scope of the present disclosure.

What is claimed is:

1. An exterior accessory pack for a musical instrument case, comprising:
a sleeve dimensioned to receive within it a musical instrument case body having first and second openings located at either end of said sleeve through which said musical instrument case is inserted, and a third opening defined in the sleeve between said ends.

2. The exterior accessory pack of claim 1, wherein said first opening is smaller than said second opening.

3. The exterior accessory pack of claim 1, one or more pockets located on the outer surface of said sleeve; and wherein said sleeve comprises a relatively elastic, flexible, lightweight material.

4. The exterior accessory pack of claim 3, wherein said sleeve is uniformly woven into a single piece of material.

5. The exterior accessory pack of claim 3, wherein said sleeve is formed of a material that is one of a knit, and a woven material.

6. The exterior accessory pack of claim 5, wherein said sleeve comprises a single sheet of generally rectangular-shaped material, and wherein first and second edges of said sheet are coupled together with a seam.

7. The exterior accessory pack of claim 6, wherein said first opening is smaller than said second opening.

8. The exterior accessory pack of claim 3, wherein at least one opening includes one of a drawstring and an elastic band for reducing the diameter of said first and second openings.

9. The exterior accessory pack of claim 1, wherein said sleeve comprises four generally rectangular-shaped panels of material coupled together such that the sleeve is generally box-shaped.

10. The exterior accessory pack of claim 9, wherein said first opening is smaller than said second opening.

11. The exterior accessory pack of claim 9, further comprising a drawstring positioned around the rim of the second opening.

12. An exterior accessory pack for a musical instrument case, comprising:
a. a sleeve having:
an upper opening located at the top of said sleeve;
a lower opening located at the bottom of said sleeve; and
an aperture located on the side of said sleeve; and
b. one or more pockets located on the outside of said sleeve; and
wherein said sleeve comprises flexible, lightweight material, and wherein said sleeve is dimensioned such that the inner surface of said sleeve fits snugly to the outer surface of said musical instrument case.

13. The exterior accessory pack of claim 12, wherein said upper opening is smaller than said lower opening such that said lower opening will fit around a lower portion of said musical instrument case but said upper opening will not fit around said lower portion.

14. The exterior accessory pack of claim 12, wherein said sleeve is generally cylinder-shaped.

15. The exterior accessory pack of claim 13, wherein at least one opening includes one of a drawstring and an elastic band for reducing the diameter of said opening.

16. The exterior accessory pack of claim 14, wherein said sleeve is formed from an elastic material.

17. The exterior accessory pack of claim 15, wherein said sleeve comprises a single sheet of generally rectangular-shaped material, and wherein opposing edges of said sheet are coupled together with a seam.

18. The exterior accessory pack of claim 12, wherein said sleeve comprises four rectangular-shaped panels coupled to one another such that said sleeve is generally box-shaped.
